(19) United States
(12) Patent Application Publication
(10) Pub. No.: US 2003/0052295 A1
(43) Pub. Date: Mar. 20, 2003

(54) Valve apparatus and method

(76) Inventors: Daniel Morgan, West Allis, WI (US); Larry Halverson, Waukesha, WI (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 09/955,221

(22) Filed: Sep. 19, 2001

(51) Int. Cl. F16K 1/22

(52) U.S. Cl. 251/305

(57) ABSTRACT

A valve apparatus is disclosed that includes a valve housing, a valve disc, a valve stem, and a handle for operating the valve apparatus between an open and closed position. The apparatus may be integrated with a transformer and a radiator, such that when the handle is rotated to an open position, the disc opens the valve apparatus and does not extend beyond an end surface of the housing of the valve apparatus.

### FIELD OF THE INVENTION

The present invention relates generally to power distribution networks. More particularly, the present invention relates to a valve assembly for transformers.

### BACKGROUND OF THE INVENTION

Electrical transformers are utilized in power distribution networks, such as those used to deliver electricity to homes. Presently, transformers can be designed to transmit hundreds of megawatts of power at voltages of 700 kV and beyond for distances of several hundred miles. The transmission of large amounts of power, by transformers, generates a significant amount of heat. Typically, radiators are attached to liquid-filled transformers, and utilized for cooling the liquid that flows through the transformer.

Radiator valves may be integrated with the transformer, and fitted with a radiator to control flow of a fluid between the transformer and the radiator. The radiator valves also make it possible to remove the radiator from the transformer without draining the fluid, which may be oil from the transformer. Typically, radiator valves are designed to accommodate the design of a specific type of radiator.

When fitting a radiator to a radiator valve, problems may arise if the sealing surface, between the radiator and the transformers, projects beyond the plane of the valve sealing surface and interferes with the opening of the radiator valve.

Accordingly, it is desirable to provide to provide a sealing surface that does not interfere with the opening of the radiator valve.

### SUMMARY OF THE INVENTION

In one aspect of the invention, a valve apparatus is provided that includes a valve, a valve disc located within the valve, and a valve stem, wherein the valve stem pivotally connects the valve disc to the valve and operates in an open position and a closed position, and wherein the valve disc does not extend beyond the beyond the valve when in the open position.

In another aspect of the invention, a valve apparatus is provided that includes a valve, a valve disc located within the valve, a valve stem, and a handle connected to the valve stem, wherein the valve stem pivotally connects the valve disc to the valve and operates in an open position and a closed position, and wherein the valve disc does not extend beyond the valve when in the open position.

In another aspect of the invention, a valve apparatus is provided that includes a valve, a valve disc located within the valve, a valve stem, wherein the valve stem pivotally connects the valve disc to the valve and operates in an open position and a closed position, wherein the valve disc does not extend beyond the valve when in the open position, and a valve mounting portion integrated with the valve disc.

In another aspect of the invention, a valve apparatus is provided that includes a valve, a valve disc located within the valve, and a valve stem, wherein said valve stem pivotally connects the valve disc to the valve and operates in an open position and a closed position, wherein the valve disc does not extend beyond the valve when in the open position, and a flange portion, wherein the flange portion is larger in cross-section than the remaining portion of the valve.

In another aspect of the invention, a valve apparatus is provided that includes a valve, a valve disc located within the valve, and a valve stem, wherein said valve stem pivotally connects the valve disc to the valve and operates in an open position and a closed position, wherein the valve disc does not extend beyond the valve when in the open position, and wherein the valve disc includes a recessed portion.

In another aspect of the invention, a valve apparatus is provided that includes a valve, a valve disc located within the valve, and a valve stem, wherein said valve stem pivotally connects the valve disc to the valve and operates in an open position and a closed position, wherein the valve disc does not extend beyond the valve when in the open position, wherein said valve disc includes a recessed portion, and wherein an O-ring is accommodated within the recessed portion.

In another aspect of the invention, a valve apparatus is provided that includes a valve, a valve disc located within the valve, and a valve stem, wherein said valve stem pivotally connects the valve disc to the valve and operates in an open position and a closed position, and wherein the valve disc does not extend beyond the valve when in the open position, wherein said valve disc includes a recessed portion, and an O-ring, wherein the O-ring is accommodated within the recessed portion and has a circular cross-section.

In another aspect of the invention, a valve apparatus for attachment between a radiator and an item of equipment is provided that includes a means for providing an open position and a closed position for the valve, a means for housing the valve disc means, and a means attached to the positioning means for rotating the positioning means within the housing means, wherein when the positioning means is rotated to an open position, the positioning means does not extend beyond the housing menas.

In another aspect of the invention, a method for making a valve apparatus is provided that includes attaching a valve stem to a valve disc, and attaching the valve stem and the valve disc to a valve, such that the valve disc is operable in an open and a closed position, and wherein the valve disc does not extend beyond the valve when the valve disc is in the open position.

In another aspect of the invention, a method for making a valve apparatus is provided that includes attaching a valve stem to a valve disc, attaching the valve stem and the valve disc to a valve, such that the valve disc is operable in an open and a closed position, and wherein the valve disc does not extend beyond the valve when the valve disc is in the open position, and attaching a valve mounting portion to the valve disc, wherein the valve mounting portion is utilized for attaching the valve stem to the valve disc.

In another aspect of the invention, a method for making a valve apparatus is provided that includes attaching a valve stem to a valve disc, attaching the valve stem and the valve disc to a valve, such that the valve disc is operable in an open and a closed position, and wherein the valve disc does not extend beyond the valve when the valve disc is in the open position, and attaching a handle to the valve stem, wherein the handle is utilized to rotate the valve disc.

In another aspect of the invention, a method for making a valve apparatus is provided that includes attaching a valve stem to a valve disc, attaching the valve stem and the valve disc to a valve, such that the valve disc is operable in an open and a closed position, and wherein the valve disc does not extend beyond the valve when the valve disc is in the open position, and forming a recessed portion within the valve disc.

In another aspect of the invention, a method for making a valve apparatus is provided that includes attaching a valve stem to a valve disc, attaching the valve stem and the valve disc to a valve, such that the valve disc is operable in an open and a closed position, and wherein the valve disc does not extend beyond the valve when the valve disc is in the open position, and forming a flange portion hat is integrated with the valve and larger in cross-section than the valve.

In another aspect of the invention, a method for making a valve apparatus is provided that includes attaching a valve stem to a valve disc, attaching the valve stem and the valve disc to a valve, such that the valve disc is operable in an open and a closed position, and wherein the valve disc does not extend beyond the valve when the valve disc is in the open position, forming a recessed portion within the valve disc, and placing an O-ring within the recessed portion.

In another aspect of the invention, a method for making a valve apparatus is provided that includes attaching a valve stem to a valve disc, attaching the valve stem and the valve disc to a valve, such that the valve disc is operable in an open and a closed position, and wherein the valve disc does not extend beyond the valve when the valve disc is in the open position, forming a recessed portion within the valve disc, and placing an O-ring within the recessed portion, wherein the O-ring is circular in cross-section.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side cutaway view of a valve apparatus in accordance with the present invention, in an open position.

FIG. 2 is a side cutaway view of a valve apparatus in accordance with the present invention, in an open position.

FIG. 3 is a side sectional view of a valve apparatus in accordance with the present invention, in an closed position.

### DETAILED DESCRIPTION OF PREFERRED EMBODIMENT

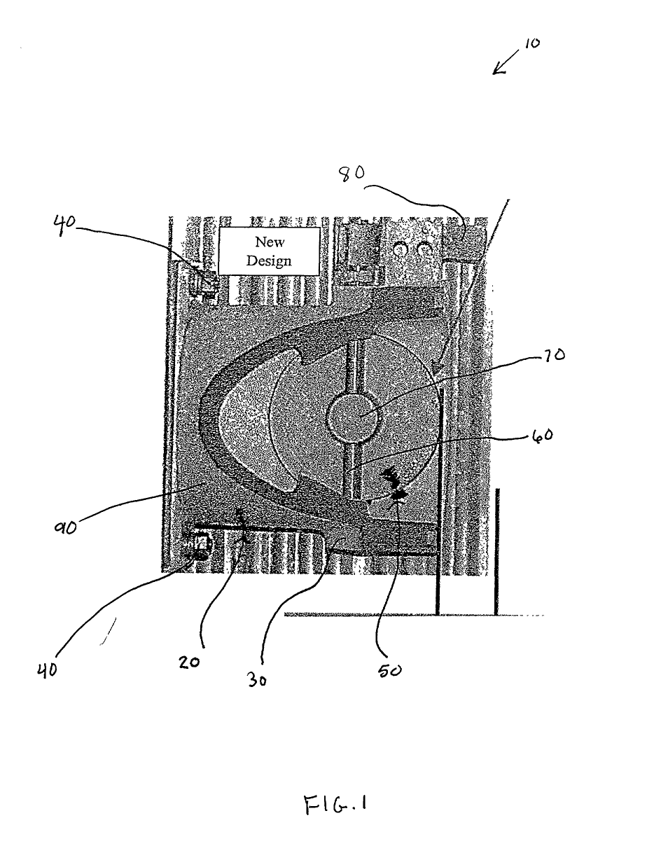

An exemplary embodiment of the present invention provides a valve device and method for integrating a radiator with a transformer. Referring now to the Figures, wherein like reference numerals indicate like elements, in FIG. 1, there is shown an embodiment of an exemplary apparatus, according to the present invention. As shown in FIG. 1, the valve apparatus 10 includes a valve 20. The valve apparatus 10 has a housing having a flange portion 30 in which a radiator (not shown) can be fitted with the valve 20. The other end of the valve apparatus 10 may be integrated with the transformer (not shown), for example, by bolts 40, which are shown in FIG. 1. By integrating the valve apparatus 10 with a transformer and a radiator, a fluid, for example, oil, can be allowed to flow between the radiator and the transformer via the valve apparatus 10.

Located within the valve 20 is a valve disc 50, as a means for providing an open and a closed position for the valve apparatus, that it is utilized to regulate the flow of a fluid between a radiator and a transformer. A valve stem 60, which is a means for rotating the positioning means, i.e., the valve disc 50, is utilized to pivotally connect the valve disc 50 with the valve 20. The valve disc 50 includes a valve mounting portion 70 through which the valve stem 60 extends. The valve mounting portion 70, as a means for attaching the positioning means to the rotating means, is raised from the valve disc 50 to accommodate the valve stem 60. The valve stem 60 is axially connected to the valve disc 50, and has two ends, each of which is rotatably mounted with a surface of the valve 20 that serves as a means for housing the valve disc. The valve mounting portion 70 is three-dimensional in nature, such that the valve stem 60 extends along a surface of the valve disc 50.

The valve apparatus 10 may also have a handle 80 for operating the valve apparatus 10. The handle 80 is connected to the valve stem 60, such that when the handle 80 is rotated, the valve stem 60 is rotated. Because the valve disc 50 is attached to the stem, the valve disc 50 rotates when the handle 80 rotates. As shown in FIG. 1, the handle 80, as a means for moving the rotating means, is in a position, such that the valve disc 50 is positioned to open flow between a radiator and a transformer. The valve disc 50 is positioned within the valve apparatus 10, such that when the handle 80 is operated to open flow between a radiator and a transformer, the valve disc 50 does not extend beyond an edge of the valve apparatus 10 and interfere with the fitting of a radiator to the valve apparatus 10.

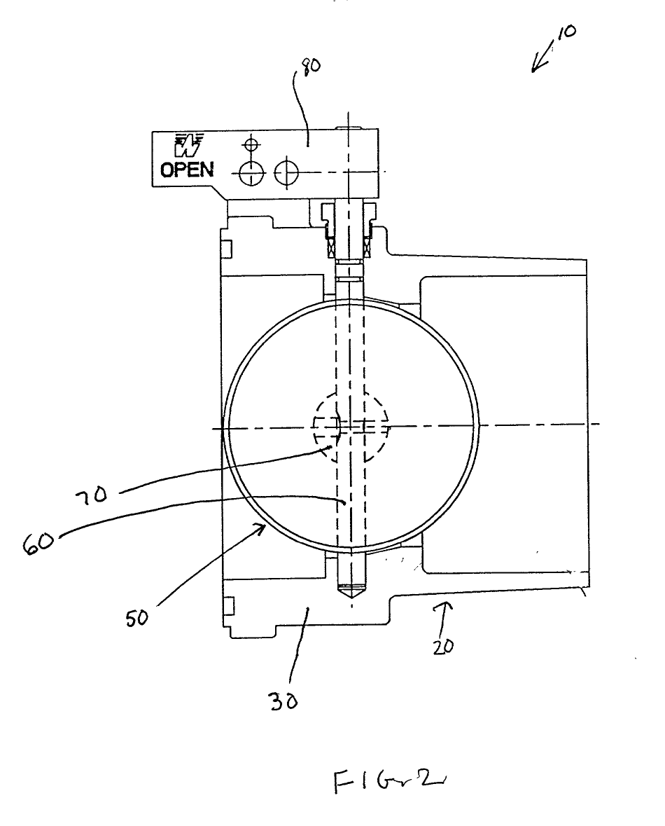

FIG. 2 also illustrates an exemplary embodiment of a valve apparatus 10, in accordance with the present invention. In FIG. 2, the valve assembly is in an open position. In an exemplary embodiment of a valve apparatus 10, in accordance with the present invention, the valve 20 is not uniform in inner and exterior width. As shown in FIG. 2, the flow passage within the valve 20 narrows beyond the flange portion 30 before becoming wider again, so as to accommodate the valve disc 50 within the valve 20. The valve disc 50 is accommodated within the valve apparatus 10 via the valve stem 60. In an exemplary embodiment, in accordance with the present invention, as shown in FIG. 2, one end of the valve stem 60 is attached to handle portion 80, and the other end of valve stem 60 is embedded within valve 20, for example, in the flange portion 30. The flange portion 30 may be greater in diameter than the remaining portion of the valve 20. Also, as shown in FIG. 2, the valve disc 50 is recessed within the valve apparatus 10, such that an edge of the valve disc 50 does not extend beyond the valve apparatus 10. Additionally, because the valve disc 50 is recessed within the valve assembly 10, the valve assembly can accommodate radiators of various designs without the valve disc 50 extending beyond the valve apparatus 10, and potentially interfering with the fitting/fit up of radiators of different designs. Further, any potential interferences with the radiator opening is eliminated. Thus, the need to fit a valve apparatus with only one type or design of a radiator is eliminated.

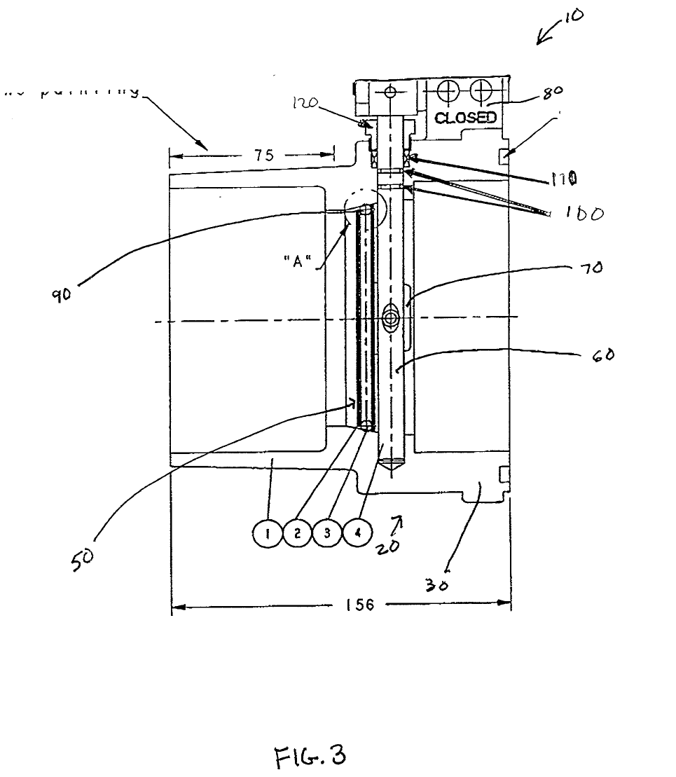

In FIG. 3, a valve apparatus 10, in accordance with an exemplary embodiment of the present invention, is shown in a closed position. When the handle 80 is rotated to the closed position, the valve disc 50 closes flow between a radiator and a transformer. The valve disc 50 may include a circular recessed portion, such as a groove, that can accommodate an O-ring 90.

In an exemplary embodiment, as shown in FIG. 3, the O-ring 90 may have a circular cross-section. The O-ring 90, as a means for providing a sealing surface to the positioning means, is placed within the valve disc 50, such that a portion of the O-ring 90 extends beyond the surface of the valve disc 50, but does not project into the space that could potentially interfere with the radiator. The O-ring provides additional sealing benefits for flow prevention.

In accordance with the present invention, there are several leak prevention features. For example, as shown in FIG. 3, the valve apparatus 10 may have at least one stem O-ring groove 100, on the valve stem 60, that prevents leakage of a fluid past the valve stem 60. Also, a bushing 1 10, positioned on the valve stem 60, may be provided that cooperates with a nut 120, also positioned on the valve stem 60. Busing 10 may be a packing bushing that is made from Teflon, and nut 120 may be a packing nut that is also made from Teflon. Thus, if the O-ring (not shown), which fits into the stem O-ring groove 100, fails to perform its sealing function, the nut 120 can be tightened to prevent the leakage of fluid past the valve stem. Accordingly, an exemplary embodiment, of the valve apparatus 10, may have at least three levels of protection against stem leaks.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is: is claimed is:

1. A valve apparatus for attachment between a radiator and an item of equipment, comprising:
a valve having a flange for attachment to the radiator;
a valve disc located within the valve; and
a valve stem that pivotally connects the valve disc to the valve and operates in an open position and a closed position, and wherein the valve disc does not extend beyond the flange when in the open position.

2. The valve apparatus according to claim 1, further comprising a handle connected to the valve stem.

3. The valve apparatus according the claim 1, further comprising a valve mounting portion integrated with the valve disc that mounts the valve disc to the valve stem.

4. The valve apparatus according to claim 1, further comprising:
a flange portion, wherein the flange portion is larger in cross-section than the remaining portion of the valve.

5. The valve apparatus according to claim 1, wherein the valve disc includes a recessed portion.

6. The valve apparatus according to claim 5, further comprising an O-ring, wherein the O-ring is accommodated within the recessed portion.

7. The valve apparatus according to claim 6, wherein the O-ring has a circular cross-section.

8. A valve apparatus for attachment between a radiator and an item of equipment, comprising:
means for providing an open position and a closed position for the valve apparatus;
means for housing the valve disc means; and
means, attached to the positioning means, for rotating the positioning means within the housing means, wherein when the positioning means is rotated to an open position, the positioning means does not extend beyond the housing means.

9. The valve apparatus according to claim 8, further comprising:
means, attached to said positioning means, for moving the rotating stem means.

10. The valve apparatus according to claim 8, further comprising:
means for attaching the positioning means to the rotating means, wherein the attaching means is located on the positioning means.

11. The valve apparatus according to claim 8, wherein the providing means includes a means for providing a sealing surface to the positioning means.

12. The valve apparatus according to claim 11, wherein the sealing member is an O-ring.

13. The valve apparatus according to claim 11, wherein the O-ring is circular in cross-section.

14. A method for making a valve apparatus or attachment between a radiator and an item of equipment, comprising the steps of:
attaching a valve stem to a valve disc; and
attaching the valve stem and the valve disc to a valve housing, such that the valve disc is operable in an open and a closed position, and wherein the valve disc does not extend beyond the valve housing when the valve disc is in the open position.

15. The method according to claim 14, further comprising the step of attaching a valve mounting portion to the valve disc, wherein the valve mounting portion is utilized for attaching the valve stem to the valve disc.

16. The method according to claim 14, further comprising the step of:
attaching a handle to the valve stem, wherein the handle is utilized to rotate the valve disc.

17. The method according to claim 14, further comprising the step of:
forming a flange portion on the housing that is integrated with the valve and larger in cross-section than the valve.

18. The method according to claim 14, further comprising the step of forming a recessed portion within the valve disc.

19. The method according to claim 18, further comprising the step of placing an O-ring within the recessed portion.

20. The method according to claim 19, wherein the O-ring is circular in cross-section.

21. The valve apparatus according to claim 1, further comprising:
at least one stem O-ring groove positioned on the valve stem.

22. The valve apparatus according to claim 1, further comprising:
a bushing positioned on the valve stem.

23. The valve apparatus according to claim 1, further comprising a nut positioned on the valve stem.

24. The method according to claim 8, wherein the rotating means is a valve disc.

25. The method according to claim 8, wherein the positioning means is a valve stem.

26. The method according to claim 8, wherein the housing means is a valve.

27. The method according to claim 9, wherein the moving means is a handle.

28. The method according to claim 10, wherein the attaching means is a mounting portion.
